(19) United States
(12) Patent Application Publication
(10) Pub. No.: US 2006/0044131 A1
(43) Pub. Date: Mar. 2, 2006

(54) Controlling turn signaling in a vehicle

(76) Inventor: Vipul M. Patel, Livonia, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/930,532

(22) Filed: Aug. 31, 2004

(51) Int. Cl. B60Q 1/34; B60Q 1/40

(52) U.S. Cl. 340/476; 340/465

(57) ABSTRACT

A turn signal control system for a vehicle having a turn signal indicator includes a wheel position sensor that senses a position of a wheel of the vehicle. A turn signal control module switches off the turn signal indicator based on input from the sensor. This system eliminates a need for a complex return mechanism for returning a turn signal stalk to a neutral position.

### FIELD OF THE INVENTION

The present invention relates generally to vehicle control systems, and more particularly to vehicle turn signal control systems.

### BACKGROUND OF THE INVENTION

A driver of a vehicle may activate a turn signal stalk on the vehicle steering column to indicate that the vehicle is about to make a left or right turn. The stalk includes a switch that activates signal lights to indicate the appropriate turn direction. When the turn is completed, a mechanism activated by the stalk interacts with the steering column to cause the stalk to return to a neutral position, thereby switching off the signal lights. The mechanism for returning the stalk to the neutral position can be quite complex and therefore expensive to manufacture and maintain.

### SUMMARY OF THE INVENTION

The present invention, in one embodiment, is directed to a turn signal control system for a vehicle having a turn signal indicator. The system includes a wheel position sensor that senses a position of a wheel of the vehicle, and a turn signal control module that switches off the turn signal indicator based on input from the wheel position sensor.

In another embodiment, a turn signal control system for a vehicle includes a turn signal initiating device that initiates a turn signal sequence. A sensor senses a position of a wheel of the vehicle. A turn signal control module uses input from the sensor to determine whether the vehicle has completed a turn and ends the turn signaling sequence based on the determining.

In yet another configuration, the invention is directed to a method of performing a turn signal sequence initiated in a vehicle by a user. The method is implemented by a turn signal control system. A turn signal is activated in response to the initiating. It is determined whether the vehicle has completed a turn. The determining is performed using input of a wheel position sensor. The turn signal is deactivated based on the determining.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an embodiment of a turn signal control system;

FIG. 2 is a flow diagram of a method of performing a turn signal sequence according to one embodiment of the present invention; and

FIG. 3 is a block diagram of an embodiment of a turn signal control system.

### DETAILED DESCRIPTION OF EXEMPLARY EMBODIMENTS

The following description of various embodiments of the present invention is merely exemplary in nature and is in no way intended to limit the invention, its application, or uses. For purposes of clarity, the same reference numbers will be used in the drawings to identify similar elements. As used herein, the term module and/or device refers to an application specific integrated circuit (ASIC), an electronic circuit, a processor (shared, dedicated, or group) and memory that execute one or more software or firmware programs, a combinational logic circuit, or other suitable components that provide the described functionality.

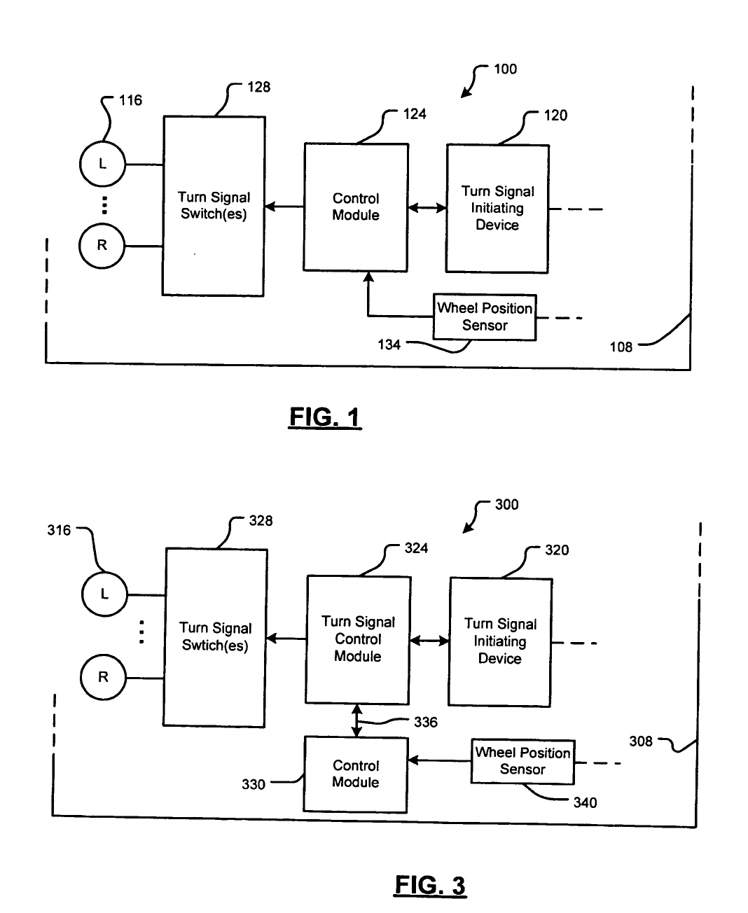

An embodiment of a turn signal control system is indicated generally in FIG. 1 by reference number 100. The system 100 is installed in a vehicle 108 having a steering wheel (not shown). The vehicle 108 includes a plurality of turn signal indicators 116 mounted, for example, on the vehicle front and rear. As shown in FIG. 1, the vehicle 108 has left and right turn signal indicators 116. Cars, trucks and other vehicles typically include at least left and right front and rear indicator lights, as well as indicator lights inside the vehicle for signaling to the driver when a turn signal light on the vehicle exterior is activated. Accordingly, more than two indicators 116 are contemplated in many other configurations.

A user can activate a turn signal initiating device 120, for example, by moving a turn signal stalk mounted to a steering column of the vehicle, to initiate a turn signal sequence as further described below. It should be noted, however, that in other embodiments, other types of turn signal initiating devices may be used. For example, a turn signal initiating device is described in U.S. patent application Ser. No. ______, (Attorney Docket No. GP-303739), filed on the same date as the present application and entitled “Facilitating Signaling In a Vehicle”, the disclosure of which is incorporated herein by reference in its entirety.

The turn signal initiating device 120 is connected with a turn signal control module 124. The turn signal control module 124 is connected with one or more turn signal switches 128 which are operable to activate and/or deactivate the turn signals 116 as further described below.

One or more wheel position sensors 134 provide input to the module 124. A wheel position sensor 134 senses information from which a position of a wheel of the vehicle can be determined. Such wheel may include, for example, the steering wheel and/or one or more driven and/or non-driven wheels of the vehicle. A sensor 134 thus can include but is not limited to a steering wheel position sensor in a stability system and/or electric steering system of the vehicle 108. Other types of wheel position sensors also could be used to provide information to the turn signal control module 124 for determining whether a turn has been completed by the vehicle 108. For example, differences in wheel rotation detected by an anti-lock braking system (ABS) could be used to indicate whether a turn has been completed.

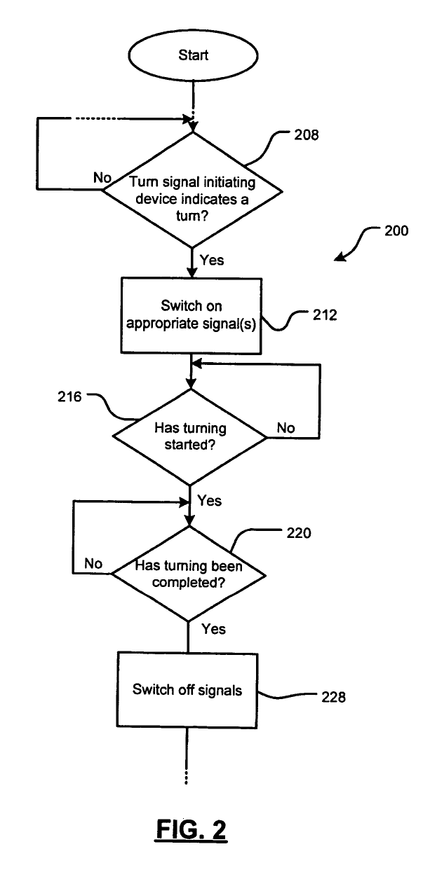

A user of the vehicle 108 may initiate a turn signal sequence by activating the turn signal initiating device 120. In one embodiment, the control system 100 performs a turn signal sequence in accordance with a method indicated generally in FIG. 2 by reference number 200. At step 208, the turn signal control module 124 determines whether the turn signal initiating device 120 is indicating, for example, a right or left turn. If a turn is indicated, the turn signal control module 124 at step 212 activates the appropriate switches 128 to activate the appropriate signals 116. The system 100 then determines at step 216 whether the vehicle has started to turn. The determination at step 216 can be made using input from the wheel position sensor(s) 134, e.g., by determining whether the steering wheel is being moved in the direction indicated by the turn signal initiating device 120. If it is determined at step 216 that turning has started, control transfers to step 220, where it is determined whether the turn has been completed. A turn can be determined to have been completed, for example, where it is determined that the steering wheel is positioned so as to position steered wheels of the vehicle to move the vehicle in a straight line. In a vehicle having ABS, differences in rotation, for example, by front wheels of the vehicle 108 could be compared to determine whether a vehicle is entering or coming out of a turn. Specifically, converging rotation rates of the front wheels could indicate that the vehicle 108 is completing a turn.

If it is determined at step 220 that the turn is completed, at step 228 the turn signal control module 124 activates the switches 128 to switch off the appropriate signals 116. The turn signal control module 124 may also return the turn signal initiating device 120 to a neutral state. For example, in a configuration in which the device 120 includes a turn signal stalk, the turn signal control module 124 may cause the stalk to be released from a depressed position after a left turn, or from an elevated position after a right turn.

It should be noted that the turn signal control module 124 can deactivate the signals 116 independently of the turn signal initiating device 120. Once the user uses the device 120 to initiate a turn signal sequence, the device 120 could be returned to a neutral state at any time, e.g., during the turn signal sequence. In some configurations, the device 120 could be returned to a neutral state by means other than the turn signal control module 124. For example, in a configuration in which the device 120 includes a turn signal stalk, the stalk could be biased in a neutral position to which it returns automatically when released by the user after initiating a turn signal sequence. Referring to FIG. 2, in one configuration, a timer may be set when a signal 116 is activated at step 212. If turning does not begin within a period of time determined by the timer, the turn signal sequence is terminated, the appropriate signal 116 is switched off, and the turn signal initiating device 120 may be returned to a neutral state.

Another embodiment of a turn signal control system is indicated generally in FIG. 3 by reference number 300. The system 300 is installed in a vehicle 308 having a steering wheel (not shown). The vehicle 308 includes one or more turn signal indicators 316. As shown in FIG. 3, the vehicle 308 has left and right turn signal indicators 316, as widely known in the art.

A user can activate a turn signal initiating device 320, for example, a turn signal stalk, to initiate a turn signal sequence as previously described with reference to FIGS. 1 and 2. The turn signal initiating device 320 is connected with a turn signal control module 324. The turn signal control module 324 controls a plurality of turn signal switches 328 to switch turn signals 316 on and/or off as previously described with reference to FIGS. 1 and 2. The turn signal control module 324 is in communication with another control module 330 via a communications bus 336. The control module 330 may include but is not limited to an electric steering system controller, stability system controller, and/or other module that receives input from one or more wheel position sensors 340.

A sensor 340 senses information useful in determining whether the vehicle 308 has completed a turn. For example, in an embodiment wherein the control module 330 includes a stability system controller, a sensor 340 may include a steering wheel position sensor. In another embodiment wherein the control module 330 includes an electric steering system controller, a sensor 340 may include one or more sensors that monitor steering wheel input from the user and/or steering gear position. Other and additional types of sensors, e.g., sensing in connection with an ABS system as previously described, could be used to provide information to the turn signal control module 324 for determining whether a turn has been completed.

Because turn signals are switched off based on sensor input to a control module, there is no longer a need for a complex return mechanism for returning a turn signal stalk to a neutral position. When the foregoing systems and methods are implemented in connection with vehicles, turn signal control is less complex and therefore can be provided at lower cost than previously possible. The foregoing system provides higher quality, reliability and durability compared to turn signal control systems currently in use.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and the following claims.

What is claimed is:

1. A turn signal control system for a vehicle having a turn signal indicator, said system comprising:
a wheel position sensor that senses a position of a wheel of the vehicle; and
a turn signal control module that switches off the turn signal indicator based on input from said wheel position sensor.

2. The turn signal control system of claim 1 wherein said turn signal control module switches off the turn signal indicator based on sensor input indicating that a turn is completed.

3. The turn signal control system of claim 1 further comprising a turn signal initiating device;
wherein said turn signal control module switches off the turn signal indicator independently of said turn signal initiating device.

4. The control system of claim 3 wherein said turn signal control module uses said input from said wheel position sensor to determine whether a turn initiated by said turn signal initiating device is completed.

5. The control system of claim 1 wherein said turn signal control module activates the turn signal indicator based on input from said turn signal initiating device.

6. The control system of claim 1 further comprising:
another control module of the vehicle; and
a bus connecting said turn signal control module with said other control module;
wherein said other control module receives input from said wheel position sensor determinative of whether a turn is completed and communicates said input to said turn signal control module via said bus.

7. The control system of claim 6 wherein said other control module comprises at least one of an electric power steering system controller and a stability system controller.

8. The control system of claim 1 wherein said wheel position sensor is comprised by at least one of an electric power steering system controller and a stability system controller.

9. The control system of claim 1 wherein the vehicle includes a steering wheel, said wheel position sensor comprising at least one of a steering gear position sensor and a sensor that senses input from a user to the steering wheel.

10. The control system of claim 1 wherein said wheel includes at least one of a steering wheel, a driven wheel and a non-driven wheel.

11. A turn signal control system for a vehicle, said system comprising:
a turn signal initiating device that initiates a turn signal sequence;
a sensor for sensing a position of a wheel of the vehicle;
a turn signal control module that uses input from said sensor to determine whether the vehicle has completed a turn and ends the turn signaling sequence based on said determining.

12. The control system of claim 11 further comprising another control module and a bus connecting the other control module with the turn signal control module;
wherein the other control module delivers said input from said sensor to said turn signal control module via said bus.

13. The control system of claim 11 wherein said turn signal control module ends the turn signaling sequence independently of said turn signal initiating device.

14. The control system of claim 11 wherein said wheel includes at least one of a steering wheel, a driven wheel and a non-driven wheel.

15. The control system of claim 11 wherein said wheel position sensor is comprised by at least one of an electric power steering system controller and a stability system controller.

16. The control system of claim 11 wherein the vehicle includes a steering wheel, said wheel position sensor comprising at least one of a steering gear position sensor and a sensor that senses input from a user to the steering wheel.

17. A method of performing a turn signal sequence initiated in a vehicle by a user, said method implemented by a turn signal control system and comprising:
activating a turn signal in response to the initiating;
determining whether the vehicle has completed a turn, said determining performed using input of a wheel position sensor; and
deactivating the turn signal based on said determining.

18. The method of claim 17 wherein said determining comprises determining a position of at least one of a steering wheel, a driven wheel and a non-driven wheel of the vehicle.

19. The method of claim 17 wherein the turn signal sequence is initiated using a turn signal initiating device, said method further comprising returning the turn signal initiating device to a neutral state.

20. The method of claim 19 wherein said deactivating is performed independently of said returning.
